(19) United States
(12) Patent Application Publication
(10) Pub. No.: US 2020/0070992 A1
(43) Pub. Date: Mar. 5, 2020

(54) Aircraft Pylon Central Fairing Comprising At Least One Articulated Panel, And Aircraft Equipped With Said Central Fairing

(71) Applicant: Airbus Operations S.A.S., Toulouse (FR)

(72) Inventor: Thierry Theron, Colomiers (FR)

(73) Assignee: Airbus Operations S.A.S., Toulouse (FR)

(21) Appl. No.: 16/539,350

(22) Filed: Aug. 13, 2019

(30) Foreign Application Priority Data
Sep. 4, 2018 (FR) 18 57942

(51) Int. Cl. B64D 29/02; B64F 5/40

(52) U.S. Cl. CPC B64D 29/02; B64D 2027/264; B64F 5/40

(57) ABSTRACT

A central fairing of a pylon of an aircraft including: at least one opening to allow access to beneath the central fairing, an articulated panel that is able to move between a closed position in which the articulated panel blocks the opening and an open position in which the articulated panel at least partially frees the opening, at least one articulation for permanently connecting the articulated panel to at least one fixed element, and—at least one locking system for holding the articulated panel in the closed position. Since the articulated panel is always connected to the aircraft, it can be made larger since it is no longer carried by the operator. Consequently, the opening can be blocked with a single articulated panel.

### FIELD OF THE INVENTION

The present application relates to a central fairing of an aircraft pylon comprising at least one articulated panel, and to an aircraft equipped with said central fairing.

### BACKGROUND OF THE INVENTION

According to one configuration, an aircraft 10 comprises multiple engine assemblies 12 positioned beneath the wing 14.

As shown in FIGS. 1 and 2, an engine assembly 12 comprises:
an engine 16 in which there flows a primary air flow,
a nacelle 18 positioned around the engine 16 so as to delimit, with the latter, an annular duct in which there flows a secondary air flow, and
a pylon 20 which provides the connection between the engine 16 and the wing 14.

The pylon 20 comprises a rigid primary structure which, among other things, serves to transmit forces between the engine 16 and the wing 14, and a secondary structure 22 which encloses the primary structure and reduces the drag of the pylon 20.

This secondary structure 22 comprises a front fairing 24, positioned at the front of the wing 14, two central fairings 26 on either side of the pylon 20, positioned below the wing 14 and approximately in line with the nacelle 18, and a rear fairing 28, also termed lower rear aerodynamic fairing or APF (for “aft pylon fairing”), which is positioned to the rear of the nacelle 18.

For the present application, a longitudinal direction is parallel to the axis of the engine 16.

The terms front and rear refer to the direction of flow of the primary air flow in the engine in operation, the primary air flow entering the engine at the front and leaving the engine at the rear.

The terms upper and lower refer to a position along a vertical axis, an upper element being further from the ground than a lower element when the aircraft is on the ground.

According to one embodiment, shown in FIG. 3, each central fairing 26 has an approximately planar aerodynamic surface.

In order to permit access to the interior of the secondary structure, the central fairing 26 comprises a plurality of removable panels 30.1 to 30.3 that are juxtaposed so as to block an opening, are shaped according to the aerodynamic surface of the central fairing 26 and are fixed to a chassis which is also referred to as the substructure. According to the configuration illustrated in FIG. 3, each central fairing comprises three removable panels 30.1 to 30.3.

Each one of these is configured to occupy an open position in which it frees an opening and a closed position in which it blocks the opening. In the open position, each removable panel 30.1 to 30.3 is completely detached from the rest of the central fairing 26. In the closed position, each removable panel 30.1 to 30.3 is connected to the rest of the central fairing 26 by a plurality of fasteners 32 that are positioned on its periphery with a spacing of the order of 10 cm.

The dimensions of each removable panel 30.1 to 30.3 are limited so as to not offer a large surface area that the wind might catch when an operator is handling them in the detached state, outdoors and several metres above the ground.

During an inspection or maintenance operation, and when an operator desires access beneath the central fairing 26, it is necessary to unscrew more than ten fasteners 32 (approximately twenty) in order to be able to remove each removable panel 30.1 to 30.3. During the intervention, the operator must correctly store the fasteners and each removed removable panel 30.1 to 30.3 so as to not damage it. The fact that the removable panels 30.1 to 30.3 are small means that, when work is being performed outdoors, there is a low risk of a gust of wind causing the operator, working at height, to lose balance and fall.

At the end of the intervention, the removable panels 30.1 to 30.3 must be correctly positioned so that all of the fasteners 32 can be screwed back in place.

Given the number of removable panels and fasteners, the operations of removing and reinstalling the removable panels are relatively long and time-consuming.

### BRIEF SUMMARY OF THE INVENTION

Aspects of the present invention may remedy the drawbacks of the prior art.

The invention relates to a central fairing of a pylon of an aircraft, having an aerodynamic surface that extends between a nacelle and a wing of the aircraft on one side of the pylon, said central fairing comprising a chassis, at least one fixed panel that is supported by the chassis and is shaped according to the aerodynamic surface, and at least one opening created in the fixed panel to allow access to beneath the central fairing.

According to an embodiment of the invention, the central fairing comprises:
an articulated panel that is able to move between a closed position in which the articulated panel blocks the opening and an open position in which the articulated panel at least partially frees the opening,
at least one articulation for permanently connecting the articulated panel to at least one fixed element of the pylon and/or of the wing, and
at least one locking system for holding the articulated panel in the closed position.

Since each articulated panel is always connected to the aircraft, it can be made larger since it is no longer carried by the operator. Consequently, an opening can be blocked by a single articulated panel instead of the three provided in the prior art, by virtue of which the time for freeing or closing the opening can be reduced.

Moreover, the use of a single articulated panel, instead of the three panels of the prior art, further serves to improve the aerodynamics of the fairing of the pylon since this single panel has an essentially smooth surface instead of a surface having profile variations arising from the installation of the three prior art panels on the fairing.

According to another advantage, the number of elements to be actuated during opening and closing of the articulated panel is greatly reduced, by virtue of which the time for installing and removing each articulated panel can be reduced.

According to another feature, the articulation is a pivoting connection configured to allow the articulated panel to pivot about a pivoting axis.

According to one configuration, the articulation comprises multiple pantograph-type hinges that permanently connect the articulated panel to at least one fixed element of the pylon and/or of the wing.

According to another feature, each articulated panel comprises first and second long edges, the articulation being positioned close to the first long edge and the locking system being positioned close to the second long edge.

According to one configuration, each locking system comprises multiple quarter-turn locks spread over the second long edge, at least one at each end of the long edge.

According to one variant, the articulation connects the lower long edge of the articulated panel to the fixed element of the pylon and/or of the wing.

According to another variant, the articulation connects the upper long edge of the articulated panel to the fixed element of the pylon and/or of the wing.

According to this other variant, a holding mechanism is provided for holding the articulated panel in the open position.

The invention also relates to an aircraft comprising at least one central fairing of a pylon according to one of the preceding features.

According to one configuration, the aircraft comprises left and right central fairings arranged on either side of the pylon.

### BRIEF DESCRIPTION OF THE DRAWINGS

Other features and advantages will emerge from the following description of the invention, which description is given solely by way of example, with reference to the appended drawings in which:

FIG. 1 is a perspective view of an aircraft,

FIG. 2 is a view of a secondary structure of an aircraft pylon, illustrating one configuration,

FIG. 3 is a perspective view of a central fairing of a secondary structure of an aircraft pylon, illustrating one configuration of the prior art,

FIG. 4A is a perspective view of a central fairing of a secondary structure of an aircraft pylon equipped with an articulated panel in the closed position, illustrating one embodiment of the invention,

FIG. 4B is a perspective view of the central fairing visible in FIG. 4A, the articulated panel being in the open position,

FIG. 5 is a schematic cross section of the central fairings of a pylon equipped with articulated panels (the articulated panel located on the left being in the closed position and that on the right being in the open position), illustrating a first variant of the invention, and

FIG. 6 is a schematic cross section of the central fairings of a pylon equipped with articulated panels (the articulated panel located on the left being in the closed position and that on the right being in the open position), illustrating a second variant of the invention.

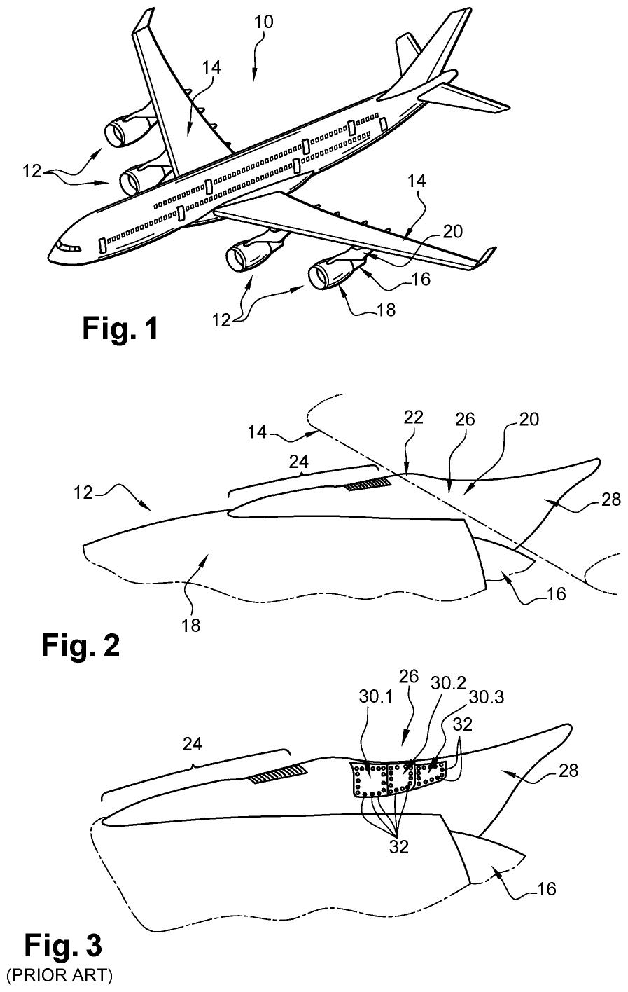

### DETAILED DESCRIPTION

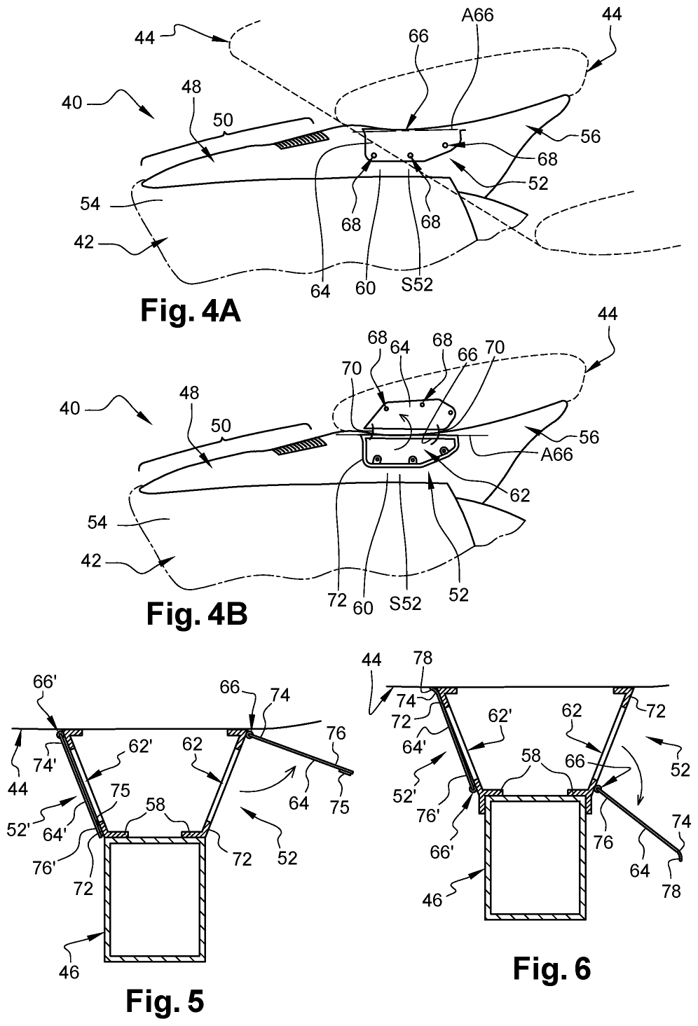

FIGS. 4A and 4B show a pylon 40 of an aircraft connecting an engine 42 to a wing 44, comprising a rigid primary structure 46, shown in FIGS. 5 and 6, which, among other things, serves to transmit forces between the engine 42 and the wing 44, and a secondary structure 48 which encloses the primary structure 46 and reduces the drag of the pylon 40.

This secondary structure 48 comprises a front fairing 50, positioned at the front of the wing 44 of the aircraft, left and right central fairings 52, 52′ on either side of the pylon 40, positioned below the wing 44 and approximately in line with the nacelle 54 of the engine 42, and a rear fairing 56, also termed lower rear aerodynamic fairing or APF (for “aft pylon fairing”), which is positioned to the rear of the nacelle 54.

In terms of geometry, each central fairing 52, 52′ has an approximately planar aerodynamic surface S52 and extends between the nacelle 54 and the wing 44 of the aircraft.

In terms of structure, each central fairing 52, 52′ comprises a chassis 58 (also referred to as the substructure) and at least one fixed panel 60 that is supported by the chassis 58 and is shaped according to the aerodynamic surface S52 of the central fairing 52, 52′.

At least one of the left or right central fairings 52, 52′ comprises:
at least one opening 62, created in the fixed panel 60, to allow access to beneath the central fairing 52, 52′,
an articulated panel 64, 64′ that is able to move between a closed position, shown in FIG. 4A and on the left in FIGS. 5 and 6, in which it blocks the opening 62 and an open position, shown in FIG. 4B and on the right in FIGS. 5 and 6, in which it at least partially frees the opening 62,
at least one articulation 66, 66′ for permanently connecting the articulated panel 64 to at least one fixed element of the pylon 40 and/or of the wing 44 among the primary structure 46, the wing 44, the chassis 58 and/or the fixed panel 60, and
at least one locking system 68 for holding the articulated panel 64 in the closed position.

According to one configuration, shown in FIGS. 5 and 6, each right-hand 52 and left-hand 52′ central fairing comprises at least one right-hand 62 or left-hand 62′ opening and a right-hand 64 or left-hand 64′ articulated panel that is permanently connected, by means of at least one right-hand 66 or left-hand 66′ articulation, to at least one fixed element of the pylon 40 and/or of the wing 44 among the primary structure 46, the wing 44, the chassis 58 and/or the fixed panel 60, said right-hand 64 or left-hand 64′ articulated panel being held in the closed position by at least one right-hand 68 or left-hand (not shown) locking system.

For each right-hand or left-hand articulated panel 64, 64′, the articulation 66, 66′ is a pivoting connection configured to allow the right-hand or left-hand articulated panel 64, 64′ to pivot about a pivoting axis A66 (shown in FIGS. 4A and 4B). According to one configuration, each pivoting axis A66 is approximately parallel to the longitudinal direction.

According to one embodiment, the right-hand and left-hand articulation 66, 66′ comprises multiple pantograph-type hinges 70 permanently connecting the right-hand or left-hand articulated panel 64, 64′ to at least one fixed element of the pylon 40 and/or of the wing 44, among the primary structure 46, the wing 44, the chassis 58 and/or the fixed panel 60.

Of course, the invention is not restricted to this embodiment. Thus, each articulation 66, 66′ could be a connection that is more complex than a pivoting connection and offer a kinematics with a combination of movements in translation and/or in rotation.

Each opening 62, 62′ comprises a peripheral rim 72 against which the articulated panel 64, 64′ presses in the closed position, this peripheral rim 72 being offset towards the interior of the pylon 40, relative to the aerodynamic surface S52, such that, in the closed position, each articulated panel 64, 64′ is flush with the aerodynamic surface S52.

According to one embodiment, shown in FIG. 5, a seal 75 is interposed between the articulated panel 64, 64′ and the peripheral rim 72, this seal being secured to either the articulated panel 64, 64′ or the peripheral rim 72.

According to one configuration, each peripheral panel 64, 64′ comprises an upper long edge 74, 74′ and a lower long edge 76, 76′.

According to a first variant, shown in FIGS. 4A, 4B, 5, the articulation 66, 66′ connects the upper long edge 74, 74′ of the articulated panel 64, 64′ to the fixed element of the pylon 40 and/or of the wing 44, among the wing 44, the chassis 58 and/or the fixed panel 60. According to this variant, a holding mechanism may be provided for holding the articulated panel 64, 64′ in the open position.

According to a second variant, shown in FIG. 6, the articulation 66, 66′ connects the lower long edge 76, 76′ of the articulated panel 64, 64′ to the fixed element of the pylon 40 and/or of the wing 44, among the primary structure 46, the chassis 58 and/or the fixed panel 60.

Whatever the variant, the upper edge 74, 74′ of each articulated panel 64, 64′ can be equipped with a seal 78 (shown in FIG. 6) that permits a relative movement between the wing 44 and the pylon 40.

Whatever the variant, each articulated panel 64, 64′ comprises first and second long edges, the articulation 66, 66′ being positioned close to the first long edge and the locking system 68 being positioned close to the second long edge.

According to one embodiment, each locking system 68 comprises multiple quarter-turn locks spread over the second long edge, at least one at each end of the long edge.

Of course, the invention is not restricted to this embodiment for the locking system. Thus, it would be possible to use the locking systems that are used to hold the cowls of a nacelle in the closed position. The use of said locking system has the advantage of avoiding potential galling of the screws used for mounting the prior art panels.

The invention provides the following advantages:

Since each articulated panel is always connected to the aircraft, it can be made larger since it is no longer carried by the operator. Consequently, a single articulated panel 64, 64′ is provided for the purpose of blocking the opening 62, 62′, instead of the three provided according to the prior art, which will help to improve aerodynamic performance and reduce the time to free or close the opening 62, 62′.

Since each articulated panel 64, 64′ is always connected to the aircraft, it is automatically correctly positioned on closing, so that it is possible to dispense with the step of the operator repositioning the articulated panel 64, 64′ during closing.

According to another advantage, the number of elements to be actuated during opening and closing of the articulated panel 64, 64′ is greatly reduced, by virtue of which the time for installing and removing each articulated panel can be reduced.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A central fairing of a pylon of an aircraft, having an approximately planar aerodynamic surface that extends, when said central fairing is installed on the aircraft, between a nacelle and a wing of the aircraft on one side of the pylon, said central fairing comprising a chassis, at least one fixed panel supported by the chassis and is shaped according to the aerodynamic surface, and at least one opening created in the fixed panel to allow access to beneath the central fairing, wherein the central fairing comprises:
an articulated panel configured to move between a closed position in which the articulated panel blocks the opening and an open position in which the articulated panel at least partially frees the opening;
at least one articulation for permanently connecting the articulated panel to at least one fixed element of the pylon and/or of the wing; and
at least one locking system for holding the articulated panel in the closed position.

2. The central fairing of a pylon of an aircraft according to claim 1, wherein the articulation is a pivoting connection configured to allow the articulated panel to pivot about a pivoting axis.

3. The central fairing of a pylon of an aircraft according to claim 1, wherein the articulation comprises multiple pantograph-type hinges that permanently connect the articulated panel to at least one fixed element of the pylon and/or of the wing.

4. The central fairing of a pylon of an aircraft according claim 1, wherein each articulated panel comprises first and second long edges, the articulation being positioned close to the first long edge and the locking system being positioned close to the second long edge.

5. The central fairing of a pylon of an aircraft according to claim 4, wherein each locking system comprises multiple quarter-turn locks spread over the second long edge, at least one at each end of the long edge.

6. The central fairing of a pylon of an aircraft according to claim 4, wherein the articulation connects the lower long edge of the articulated panel to the fixed element of the pylon and/or of the wing.

7. The central fairing of a pylon of an aircraft according to claim 4, wherein the articulation connects the upper long edge of the articulated panel to the fixed element of the pylon and/or of the wing.

8. The central fairing of a pylon of an aircraft according to claim 7, further comprising a holding mechanism for holding the articulated panel in the open position.

9. An aircraft comprising at least one central fairing of a pylon according to claim 1.

10. The aircraft according to claim 9, wherein the at least one central fairing comprises left and right central fairings arranged on either side of the pylon.
